(19) United States
(12) Patent Application Publication
(10) Pub. No.: US 2011/0171896 A1
(43) Pub. Date: Jul. 14, 2011

(54) System And Method For Pumping Recirculation Air From An Aircraft Cabin

(75) Inventors: Holger Brunnberg, Hamburg (DE); Dariusz Krakowski, Buxtehude (DE)

(73) Assignee: AIRBUS OPERATIONS GMBH, Hamburg (DE)

(21) Appl. No.: 13/056,255

(22) PCT Filed: Jul. 23, 2009
(86) PCT No.: PCT/EP2009/005362

§ 371 Date: Mar. 29, 2011

Related U.S. Application Data
(60) Provisional application No. 61/083,977, filed on Jul. 28, 2008.

(30) Foreign Application Priority Data
Jul. 28, 2008 (DE) 10 2008 035 122.9

(51) Int. Cl. B64D 13/00

(52) U.S. Cl. 454/76

(57) ABSTRACT

A system (10) for conveying recirculation air from an aircraft cabin comprises a plurality of conveying devices (12a-12j) which are arranged in a manner distributed along an aircraft cabin region (14). A control device (16) is configured to control the conveying devices (12a-12j) in the normal operation of the system (10) in such a manner that each conveying device (12a-12j) removes a predetermined air volume flow from the aircraft cabin region (14). The control device (16) is furthermore configured to control, in the event of a failure of a conveying device (12c), at least some of the remaining still functional conveying devices (12a, 12b, 12d-12j) in such a manner that the entire air volume flow removed from the aircraft cabin region (14) by the remaining still functional conveying devices (12a, 12b, 12d-12j) is increased by an amount corresponding to an air volume flow amount removed from the aircraft cabin region (14) by the failed conveying device (12c) in the normal operation of the system (10).

The present invention relates to a system and a method for conveying recirculation air from an aircraft cabin.

The cabin of a modern passenger aircraft is air-conditioned usually both when the aircraft is flying and is on the ground by means of the aircraft's own air conditioning system. The aircraft air conditioning system is supplied with bleed air which is taken from the engine compressors or auxiliary power unit compressors and cooled to a desired low temperature in the air conditioning units, the so-called air conditioning packs of the aircraft air conditioning system. The air cooled in the air conditioning packs of the aircraft air conditioning system is led into a mixer where it is mixed with recirculation air sucked from the aircraft cabin by a recirculation system. The mixed air generated in the mixer and composed of cold fresh air provided by the air conditioning packs and of recirculation air sucked from the aircraft cabin is finally led into the aircraft cabin for the air-conditioning of the aircraft cabin.

The recirculation system of a modern aircraft air conditioning system comprises a plurality of fans which can be constructed, for example, as low-pressure fans. In order to ensure a homogeneous air distribution in an aircraft cabin region, for example a deck of a wide-body aircraft, to be air-conditioned, the fans are arranged in a manner distributed along the aircraft cabin region to be air-conditioned, the rotational speed of the fans in each case being controlled in such a manner that each fan extracts a desired air volume flow from the aircraft cabin region to be air-conditioned. The air volume flow which is to be sucked from the aircraft cabin region to be air-conditioned by a fan depends on various parameters, such as e.g. the cabin equipment in the cabin region to be air-conditioned.

In the event of a failure of a fan of the recirculation system, the remaining still functional fans are controlled, in a recirculation system common at present, in such a manner that they are operated with their maximum output, i.e. their maximum rotational speed, for compensation of the air extraction output of the failed fan. This form of fault compensation is referred to as maximum compensation. A recirculation system operated with maximum compensation in the event of a failure of a fan has, however, a very high current consumption, which results in an increased fuel consumption of the aircraft. Moreover, the fans operated at full load with the recirculation system operated with maximum compensation are subjected to very high stresses, necessitating additional maintenance costs, but possibly also resulting in a higher failure rate of these fans and thus a reduced availability of the entire system.

Furthermore, a recirculation system operated with maximum compensation can result in reduction in comfort for the passengers in the aircraft cabin. On the one hand, the fans operated at full load cause turbulence in the air flow sucked from the aircraft cabin region to be air-conditioned and thus increased noise emissions. On the other hand, flow conditions can form in the aircraft cabin region to be air-conditioned which lead locally to draughts which are perceived as unpleasant. Finally, when the recirculation system is operated with maximum compensation, the actual air volume flow to be extracted from the aircraft cabin region to be air-conditioned by the failed fan in the normal operation of the system is not taken into consideration. Consequently, the entire air volume flow sucked from the aircraft cabin region to be air-conditioned by the recirculation system when it is operated with maximum compensation may be significantly greater but also less than the entire air volume flow which is removed from the aircraft cabin region to be air-conditioned in the normal operation of the recirculation system.

The invention is directed at the object of providing a system and a method for conveying recirculation air from an aircraft cabin which enable, even in the event of a failure of a conveying device of the recirculation system, an efficient operation of the entire system without reduction in comfort for the passengers in the aircraft cabin.

This object is achieved by a system for conveying recirculation air from an aircraft cabin with the features of Claim 1 and a method for conveying recirculation air from an aircraft cabin with the features of Claim 7.

A system for conveying recirculation air from an aircraft cabin according to the invention comprises a plurality of conveying devices which are arranged in a manner distributed along an aircraft cabin region to be air-conditioned. The conveying devices serve to suck exhaust air, which is intended for supplying into a mixer of an aircraft air conditioning system, from the aircraft cabin region to be air-conditioned. The conveying devices can be arranged, for example, in the region of the side walls of the aircraft cabin region to be air-conditioned, it being possible for the distribution of the conveying devices along the side walls of the aircraft cabin region to be air-conditioned to be dependent, for example, on the equipment of the aircraft cabin region to be air-conditioned and/or a division of the aircraft cabin region to be air-conditioned into different air conditioning zones. The aircraft cabin region to be air-conditioned can be any region of an aircraft cabin. In a wide-body aircraft equipped with the recirculation system according to the invention, the aircraft cabin region to be air-conditioned can be, for example, a deck of the wide-body aircraft, in particular an upper deck of the aircraft cabin.

A control device of the recirculation system according to the invention is configured to control the conveying devices in the normal operation of the recirculation system in such a manner that each conveying device removes a predetermined air volume flow from the aircraft cabin region to be air-conditioned. Preferably, the air volume flow to be removed from the aircraft cabin region to be air-conditioned by a conveying device is adapted to the association of the conveying device with a certain portion of the aircraft cabin region to be air-conditioned. For example, there exist portions of the aircraft cabin region to be air-conditioned from which large exhaust air quantities are to be removed. The control device can then control conveying devices associated with these portions of the aircraft cabin region to be air-conditioned, for example, in such a manner that they remove a predetermined air volume flow of, for example, 200 or 300 l/s from the aircraft cabin region to be air-conditioned in the normal operation of the recirculation system. In contrast to this, there may also exist portions of the aircraft cabin region to be air-conditioned from which only a smaller exhaust air volume flow is to be removed. The control device of the recirculation system can then control conveying devices associated with these portions of the aircraft cabin region to be air-conditioned, for example, in such a manner that they remove a predetermined air volume flow of only 100 l/s from the aircraft cabin region to be air-conditioned in the normal operation of the recirculation system.

In order to maximise the efficiency of the recirculation system and simultaneously minimise the system weight, the conveying devices can be adapted as regards their maximum conveying output to the demands placed on the conveying devices in the normal operation of the recirculation system. In particular, it is expedient to associate conveying devices having a smaller maximum conveying output and therefore a lower weight and a lower current consumption with portions of the aircraft cabin region to be air-conditioned from which only a small predetermined air volume flow is to be removed in the normal operation of the recirculation system. Portions of the aircraft cabin region to be air-conditioned from which a large predetermined air volume flow is to be sucked in the normal operation of the recirculation system, are, in contrast, preferably associated with conveying devices having a larger maximum conveying output. However, these conveying devices have a higher weight and a higher current consumption compared with conveying devices having a smaller maximum conveying output.

The control device of the recirculation system according to the invention is furthermore configured to control, in the event of a failure of a conveying device, at least some of the remaining still functional conveying devices in such a manner that the entire air volume flow removed from the aircraft cabin region to be air-conditioned by the remaining still functional conveying devices is increased by an amount corresponding to an air volume flow amount removed from the aircraft cabin region to be air-conditioned by the failed conveying device in the normal operation of the recirculation system. In other words, in the event of a failure of a conveying device of the recirculation system according to the invention, the conveying output of at least some of the remaining still functional conveying devices is increased. Unlike recirculation systems known from the prior art, however, the remaining still functional conveying devices are not operated with their maximum output. Instead, the entire air volume flow sucked from the aircraft cabin region to be air-conditioned by the remaining still functional conveying devices is increased, compared with the entire air volume flow sucked from the aircraft cabin region to be air-conditioned by these conveying devices in the normal operation of the recirculation system, only by an amount which corresponds to the air volume flow amount sucked from the aircraft cabin region to be air-conditioned by the failed conveying device in the normal operation of the recirculation system. The conveying output of the remaining still functional conveying systems is thus increased only by the amount which is required to compensate the conveying output of the failed conveying device.

The control device of the recirculation system according to the invention can be configured to use, in the event of a failure of a conveying device, only some of the remaining still functional conveying devices for the compensation of the failure of a conveying device. Preferably, however, all remaining still functional conveying devices are included by the control device in the operation for the compensation of the failure of a conveying device.

Unlike recirculation systems known from the prior art which change to a maximum compensation operating state in the event of a failure of a conveying device, the actual air volume flow removed from the aircraft cabin region to be air-conditioned by the failed conveying device in the normal operation of the recirculation system is taken into consideration with the system for conveying recirculation air from an aircraft cabin according to the invention in the event of a failure of a conveying device. The entire air volume flow removed from the aircraft cabin region to be air-conditioned by the remaining still functional conveying devices is increased only by an amount which is sufficient to compensate the loss of conveying output caused by the failure of the conveying device. With the recirculation system according to the invention, the entire air volume flow removed from the air-conditioning aircraft cabin region to be air-conditioned in the event of a failure of a conveying device of the recirculation system thus corresponds to the entire air volume flow which is also removed from the aircraft cabin region to be air-conditioned in the normal operation of the recirculation system in which all conveying devices of the recirculation system are functional.

Compared with a recirculation system operated with maximum compensation in the event of a failure of a conveying device, the recirculation system according to the invention is thus distinguished by a lower current consumption, so that the fuel consumption of the aircraft is also reduced. Moreover, in the recirculation system according to the invention in the event of a failure of a conveying device, the remaining still functional conveying devices do not have to be operated at full load, so that these conveying devices are preserved. Thus, the maintenance costs for these conveying devices and the failure rate of these conveying devices can be reduced and therefore the availability of the entire system improved.

Another advantage of the recirculation system according to the invention consists in the fact that, in the event of a failure of a conveying device, because the conveying device failure is compensated merely according to the requirements, the flow conditions in the aircraft cabin region to be air-conditioned are very much less affected than would be the case by a maximum compensation operation of the recirculation system. Draughts which are perceived as unpleasant by passengers in the aircraft cabin region to be air-conditioned can therefore be avoided, as can greatly increased noise emissions due to conveying devices being operated at full load. In the operation of the recirculation system according to the invention, there is therefore no reduction in comfort for the passengers in the aircraft cabin region to be air-conditioned even in the event of a failure of a conveying device.

Preferably the conveying devices of the recirculation system according to the invention are constructed in the form of fans. If the aircraft cabin region to be air-conditioned is an upper deck of a wide-body aircraft, the conveying devices can be constructed, for example, as low-pressure fans. The control device of the recirculation system according to the invention can then be configured, for controlling the air volume flow removed from the aircraft cabin region to be air-conditioned by the conveying devices, to control a rotational speed of the conveying devices, constructed in the form of fans.

The control device of the recirculation system according to the invention can be furthermore configured to control, in the event of a failure of a conveying device of the recirculation system, at least some of the remaining still functional conveying devices in such a manner that the remaining still functional conveying devices each remove an air volume flow from the aircraft cabin region to be air-conditioned which is increased by the same amount. In other words, the control device can control the remaining still functional conveying devices in such a manner that the failure of the conveying device is uniformly compensated by the remaining still functional conveying devices. Consequently, the remaining still functional conveying devices each convey an air volume flow from the aircraft cabin region to be air-conditioned which is obtained from the sum of the air volume flow removed from the aircraft cabin region to be air-conditioned by the conveying devices in the normal operation of the recirculation system and the air volume flow to be additionally removed from the aircraft cabin region to be air-conditioned for the compensation of the conveying device failure. The additional air volume flow to be conveyed by each remaining still functional conveying device for the compensation of the conveying device failure is calculated from the quotient of the air volume flow removed from the aircraft cabin region to be air-conditioned by the failed conveying device in the normal operation of the recirculation system and the number of the remaining still functional conveying devices.

If, for example, in a recirculation system which comprises ten conveying devices, a conveying device which removes an air volume flow of 200 l/s from the aircraft cabin region to be air-conditioned in the normal operation of the recirculation system fails, the control device can control at least some of the nine remaining still functional conveying devices in such a manner that they are operated with a uniformly increased conveying volume which is sufficient to compensate the loss of conveying volume of 200 l/s caused by the failure of the conveying device. If the control device includes all nine remaining still functional conveying devices in the compensation operation, the conveying volume of 200 l/s to be compensated is distributed among the nine remaining still functional conveying devices, so that each of the remaining still functional conveying devices has to extract an additional air volume flow of approx. 22.2 l/s from the aircraft cabin region to be air-conditioned. Alternatively to this, it is of course also conceivable that only some of the nine remaining still functional conveying devices will be used by the control device for the compensation of the failure of a conveying device with a conveying volume of 200 l/s. The additional air volume flow to be conveyed by these conveying devices is then increased accordingly and is obtained once again from the quotient of the air volume flow removed from the aircraft cabin region to be air-conditioned by the failed conveying device in the normal operation of the recirculation system and the number of the remaining still functional conveying devices used for the compensation of the conveying device failure.

Alternatively or additionally to this, the control device of the system for conveying recirculation air from an aircraft cabin according to the invention can also be configured to control, in the event of a failure of a conveying device, at least some of the remaining still functional conveying devices in such a manner that the remaining still functional conveying devices each remove an air volume flow from the aircraft cabin region to be air-conditioned which is increased by an amount which is determined by the control device in dependence on at least one parameter. In other words, the control device can distribute the air volume flow, to be additionally conveyed from the aircraft cabin region to be air-conditioned by the remaining still functional conveying devices due to a failure of a conveying device, in dependence on at least one parameter in a weighted manner among the remaining functional conveying devices.

In principle, the control unit of the recirculation system according to the invention can provide only a uniform or only a weighted distribution of the conveying volume of a failed conveying device to be compensated among the remaining functional conveying devices. Alternatively to this, however, the control device can also be configured to provide either a uniform or a weighted distribution of the conveying volume flow of a failed conveying device to be compensated among the remaining still functional conveying devices, depending on the operating situation.

Serving as the parameter(s) which can be used by the control device, in the event of a failure of a conveying device, to control at least some of the remaining still functional conveying devices is/are, for example, a parameter characteristic of the arrangement of the remaining still functional conveying devices relative to the failed conveying device and/or a parameter characteristic of the maximum output of the remaining still functional conveying devices. The parameter characteristic of the arrangement of a remaining still functional conveying device relative to the failed conveying device can be, for example, the distance of the remaining still functional conveying device from the failed conveying device.

In particular, the control device of the recirculation system according to the invention is configured to control, in the event of a failure of a conveying device, the operation of at least some of the remaining still functional conveying devices in dependence on the parameter characteristic of the arrangement of the remaining still functional conveying devices relative to the failed conveying device, in such a manner that the air volume flow removed from the aircraft cabin region to be air-conditioned by a remaining still functional conveying device is increased by a greater amount, the closer the arrangement of the remaining still functional conveying device to the failed conveying device. In other words, remaining still functional conveying devices arranged at a smaller distance from the failed conveying device are operated in such a manner that they convey a higher proportion of the air volume flow conveyed by the failed conveying device in the normal operation of the recirculation system and to be compensated than remaining still functional conveying devices which are arranged further away from the failed conveying device.

For example, in the event of a failure of a conveying device which conveys an air volume flow of 200 l/s in the normal operation of the recirculation system, a weighted distribution of the air volume flow to be compensated, i.e. to be taken over by the remaining still functional conveying devices, can take place in such a manner that remaining still functional conveying devices directly adjacent to the failed conveying device remove an additional air volume flow of 40 l/s from the aircraft cabin region to be air-conditioned. In contrast, remaining still functional conveying devices which are further away can be operated in such a manner that they only have to convey an additional air volume flow of 35, 30, 25, 10 or 5 l/s. With a weighted compensation of the failure of a conveying device, the flow conditions which arise in the normal operation of the recirculation system according to the invention in the aircraft cabin region to be air-conditioned, are affected to a particularly small degree. Reduction in comfort for the passengers in the aircraft cabin region to be air-conditioned can thus be avoided in a particularly reliable manner.

With a method for conveying recirculation air from an aircraft cabin according to the invention, a control device controls a plurality of conveying devices which are arranged in a manner distributed along an aircraft cabin region, in the normal operation of the recirculation system, in such a manner that each conveying device removes a predetermined air volume flow from the aircraft cabin region to be air-conditioned. In the event of a failure of a conveying device, the control device controls at least some of the remaining still functional conveying devices in such a manner that the entire air volume flow removed from the aircraft cabin region to be air-conditioned by the remaining still functional conveying devices is increased by an amount corresponding to an air volume flow amount removed from the aircraft cabin region to be air-conditioned by the failed conveying device in the normal operation of the recirculation system. With the method according to the invention, the control device can use, in the event of a failure of a conveying device, only some of the remaining still functional conveying devices for the compensation of the failure of a conveying device. Preferably, however, all remaining still functional conveying devices are included by the control device in the operation for the compensation of the failure of a conveying device.

The control device, for controlling the air volume flow removed from the aircraft cabin region to be air-conditioned by the conveying devices, can control a rotational speed of the conveying devices, constructed in the form of fans, for example low-pressure fans.

The control device can control, in the event of a failure of a conveying device, at least some of the remaining still functional conveying devices in such a manner that the remaining still functional conveying devices each remove an air volume flow from the aircraft cabin region to be air-conditioned which is increased by the same amount. In other words, the control device can control the remaining functional conveying devices in such a manner that the air volume flow to be compensated due to the failure of a conveying device is distributed in equal parts among the remaining still functional conveying devices.

Furthermore, the control device can control, in the event of a failure of a conveying device, at least some of the remaining still functional conveying devices in such a manner that the remaining still functional conveying devices each remove an air volume flow from the aircraft cabin region to be air-conditioned which is increased by an amount which is determined by the control device in dependence on at least one parameter. In other words, the control device can provide a weighted distribution of the air volume flow to be compensated due to the failure of a conveying device among the remaining functional conveying devices. In principle, the control device can always provide a uniform distribution or a weighted distribution of the air volume flow to be compensated due to the failure of a conveying device among the remaining still functional conveying devices. Alternatively to this, however, the control device can also provide either a uniform or a weighted distribution of the air volume flow to be compensated among the remaining still functional conveying devices, depending on the operating situation.

For example, the control device can use a parameter characteristic of the arrangement of the remaining still functional conveying devices relative to the failed conveying device. This characteristic parameter can be, for example, the distance of a remaining still functional conveying device from the failed conveying device. Alternatively or additionally to this, with the weighted distribution of the air volume flow to be compensated among the remaining still functional conveying devices, the control device can also take into consideration a parameter which is characteristic of the maximum output of the remaining still functional conveying devices.

Preferably, the control device controls, in the event of a failure of a conveying device, the operation of at least some of the remaining still functional conveying devices in dependence on the parameter characteristic of the arrangement of the remaining still functional conveying devices relative to the failed conveying device, in such a manner that the air volume flow conveyed from the aircraft cabin region to be air-conditioned by a remaining still functional conveying device is increased by a greater amount, the closer the arrangement of the remaining still functional conveying device to the failed conveying device. In other words, in the event of a failure of a conveying device, remaining still functional conveying devices which are arranged in close proximity to the failed conveying device take over a larger proportion of the air volume flow to be compensated due to the failure of the conveying device than remaining still functional conveying devices which are positioned further away from the failed conveying device.

Preferred embodiments of the invention will now be explained in more detail with the aid of the accompanying schematic figures, of which

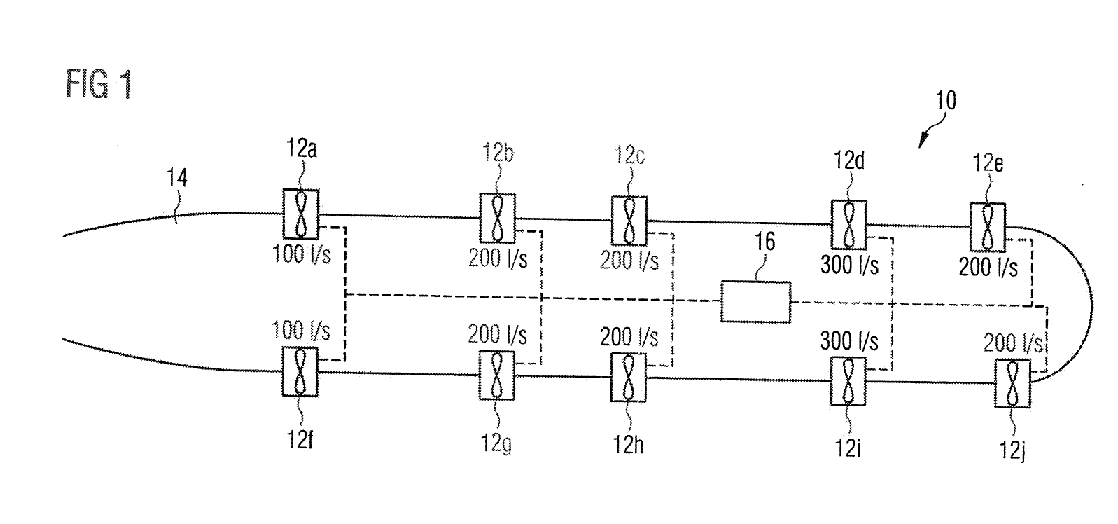

FIG. 1 shows a recirculation system with ten conveying devices in normal operation,

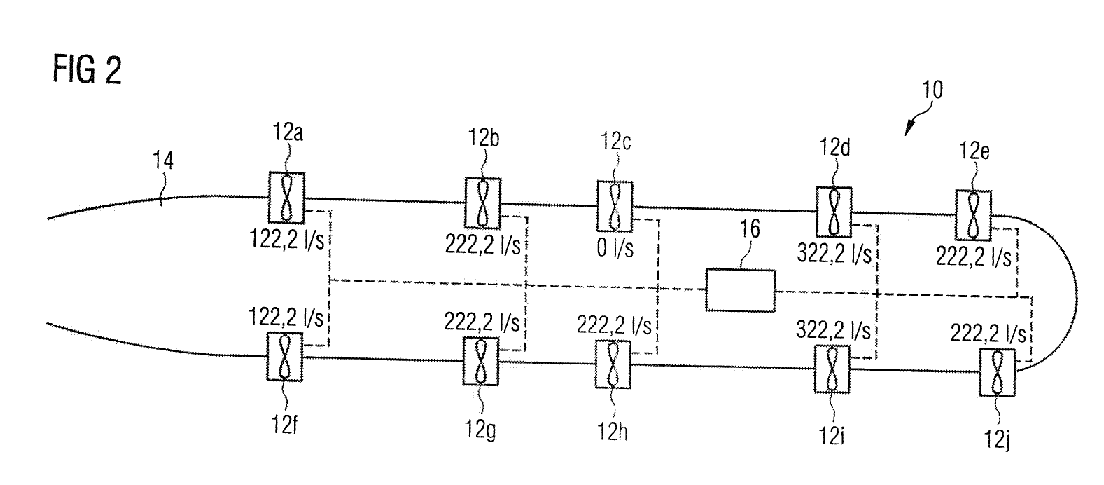

FIG. 2 shows the recirculation system in accordance with FIG. 1, with which a failure of a conveying device is compensated by a uniform distribution of the conveying output delivered in normal operation by the failed conveying device among the remaining still functional conveying devices, and

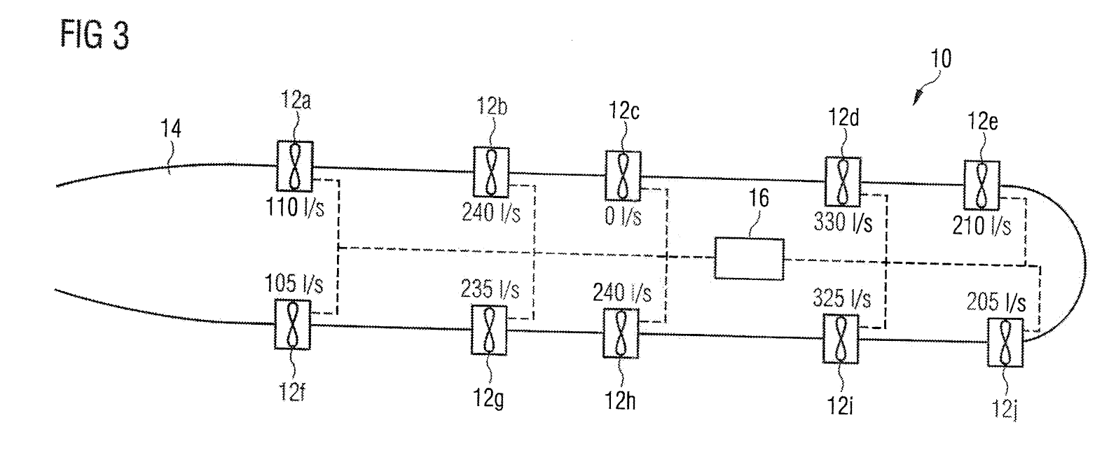

FIG. 3 shows a recirculation system in accordance with FIG. 1, with which a failure of a conveying device is compensated by a weighted distribution of the conveying output delivered in normal operation by the failed conveying device among the remaining still functional conveying devices.

A system 10 for conveying recirculation air from an aircraft cabin, shown in FIG. 1, comprises ten conveying devices 12a-17j constructed in the form of low-pressure fans. The conveying devices 12a-12j are arranged in a manner distributed along mutually opposite side walls of an aircraft cabin region 14 to be air-conditioned. In dependence on the equipment of the aircraft cabin region 14 to be air-conditioned in the region of the individual conveying devices 12a-12j, the individual conveying devices 12a-12j are operated with different conveying outputs in the normal operation of the recirculation system 10. While the conveying devices 12a and 12f in the normal operation of the recirculation system 10 remove only an air volume flow of 10 l/s from the aircraft cabin region 14 to be air-conditioned, the conveying devices 12b, 12c, 12e, 12g, 12h and 12j in the normal operation of the recirculation system 10 are operated with a conveying output of 200 l/s and the conveying devices 12d and 12e even with a conveying output of 300 l/s. The operation of the conveying devices 12a-12j is effected with the aid of an electronic control device 16.

In the following, the operation of the recirculation system 10 in the event of a failure of the conveying device 12c will now be discussed. In the normal operation of the recirculation system 10, the conveying device 12c conveys an air volume flow of 200 l/s from the aircraft cabin region 14 to be air-conditioned. For the compensation of the failure of the conveying device 12c the control device 16 controls the remaining still functional conveying devices 12a, 12b and 12d-12j now in such a manner that the entire air volume flow removed by the remaining still functional conveying devices 12a, 12b and 12d-12j, which amounts to 1800 l/s in the normal operation of the recirculation system 10, is increased by an amount which corresponds to an air volume flow of 200 l/s removed from the aircraft cabin region 14 to be air-conditioned by the failed conveying device 12c in the normal operation of the recirculation system 10. In other words, the entire air volume flow conveyed by the remaining still functional conveying devices 12a, 12b and 12d-12j is increased by 200 l/s from 1800 l/s to 2000 l/s.

As shown in FIG. 2, the electronic control device 16 can control the remaining still functional conveying devices 12a, 12b and 12d-12j in each case in such a manner that the remaining still functional conveying devices 12a, 12b and 12d-12j in each case remove an air volume flow from the aircraft cabin region 14 to be air-conditioned which is increased by the same amount. In the present case, in which the conveying output of the conveying device 12c of 200 l/s has to be compensated, an amount by which the conveying output of the remaining still functional conveying devices 12a, 12b and 12d to 12j has to be increased is obtained from the quotient of the conveying output of 200 l/s to be compensated and the number of the remaining still functional conveying devices 12a, 12b and 12d-12j. As shown in FIG. 2, with a uniform distribution of the conveying output of the failed conveying device 12c to be compensated among the remaining still functional conveying devices 12a, 12b and 12d-12j, the air volume flow removed from the aircraft cabin region 14 to be air-conditioned by the remaining still functional conveying devices 12a, 12b and 12d-12j is consequently increased by approx. 212 l/s in each case.

Alternatively to this, however, the conveying output of the failed conveying device 12c to be compensated can also be distributed in weighted form among the remaining still functional conveying devices 12a, 12b and 12d-12j. As shown in FIG. 3, in particular the distance of the individual remaining still functional conveying devices 12a, 12b and 12d-12j can be used as control parameter for the weighted distribution of the conveying output of the failed conveying device 12c to be compensated among the remaining still functional conveying devices 12a, 12b and 12d-12j. In particular, the electronic control device 16 can control the remaining still functional conveying devices 12a, 12b and 12d-12j in such a manner that the air volume flow removed from the aircraft cabin region 14 to be air-conditioned by a remaining still functional conveying device 12a, 12b and 12d-12j is increased by a greater amount, the closer the arrangement of the remaining still functional conveying device 12a, 12b and 12d-12j to the failed conveying device 12c.

In the exemplary embodiment shown in FIG. 3, the conveying output of the conveying devices 12d and 12h directly adjacent to the failed conveying device 12c is increased by 40 l/s in each case. The conveying output of the conveying device 12g arranged diagonally opposite the failed conveying device 12c is increased by 35 l/s. The conveying device 12d likewise adjacent to the failed conveying device 12c, but further away than the conveying devices 12d and 12h of the failed conveying device 12c is, in contrast, operated with a conveying output increased by 30 l/s. The air volume flow removed from the aircraft cabin region 14 to be air-conditioned by the conveying device 12i is increased by 25 l/s. The conveying devices 12a, 12e, 12f and 12j relatively far away from the failed conveying device 12c are, in contrast, operated with conveying outputs increased by only 10 l/s and 5 I/2, respectively.

1-12. (canceled)

13. System for conveying recirculation air from an aircraft cabin, with:
a plurality of conveying devices which are adapted to be arranged in a manner distributed along an aircraft cabin region, and
a control device which is configured to control the conveying devices in the normal operation of the system in such a manner that each conveying device removes a predetermined air volume flow from the aircraft cabin region,
characterized in that the conveying devices, with regard to their maximum conveying capability, are adjusted to the requirements the conveying devices face during normal operation of the system and the control device is configured to control, in the event of a failure of a conveying device, at least some of the remaining still functional conveying devices in such a manner that the entire air volume flow removed from the aircraft cabin region by the remaining still functional conveying devices is increased by an amount corresponding to an air volume flow amount removed from the aircraft cabin region by the failed conveying device in the normal operation of the system.

14. System according to claim 13,
characterized in that the conveying devices are constructed in the form of fans and the control device is configured, for controlling the air volume flow removed from the aircraft cabin region by the conveying devices, to control a rotational speed of the conveying devices.

15. System according to claim 13,
characterized in that the control device is configured to control, in the event of a failure of a conveying device, at least some of the remaining still functional conveying devices in such a manner that the remaining still functional conveying devices remove an air volume flow from the aircraft cabin region which is in-creased by the same amount.

16. System according to claim 13,
characterized in that the control device is configured to control, in the event of a failure of a conveying device, at least some of the remaining still functional conveying devices in such a manner that the remaining still functional conveying devices remove an air volume flow from the aircraft cabin region which is in-creased by an amount which is determined by the control device in dependence on at least one parameter.

17. System according to claim 16,
characterized in that the parameter(s) which is/are used by the control device, in the event of a failure of a conveying device, to control at least some of the re-maining still functional conveying devices is/are a parameter characteristic of the arrangement of the remaining still functional conveying devices relative to the failed conveying device and/or a parameter characteristic of the maximum output of the remaining still functional conveying devices.

18. System according to claim 17,
characterized in that the control device is configured to control, in the event of a failure of a conveying device, the operation of at least some of the remaining still functional conveying devices in dependence on the parameter characteristic of the arrangement of the remaining still functional conveying devices relative to the failed conveying device, in such a manner that the air volume flow removed from the aircraft cabin region by a remaining still functional conveying device is increased by a greater amount, the closer the arrangement of the remaining still functional conveying device to the failed conveying device.

19. Method for conveying recirculation air from an aircraft cabin, in which a control device controls a plurality of conveying devices which are adapted to be arranged in a manner distributed along an aircraft cabin region, in the normal operation of the system, in such a manner that each conveying device removes a predetermined air volume flow from the aircraft cabin region,
characterized in that the conveying devices, with regard to their maximum con-veying capability, are adjusted to the requirements the conveying devices face during normal operation of the system and the control device controls, in the event of a failure of a conveying device, at least some of the remaining still functional conveying devices in such a manner that the entire air volume flow removed from the aircraft cabin region by the remaining still functional conveying devices is increased by an amount corresponding to an air volume flow amount removed from the aircraft cabin region by the failed conveying device in the normal operation of the system.

20. Method according to claim 19,
characterized in that the control device, for controlling the air volume flow re-moved from the aircraft cabin region by the conveying devices, controls a rotational speed of the conveying devices, constructed in the form of fans.

21. Method according to claim 19,
characterized in that the control device controls, in the event of a failure of a conveying device, at least some of the remaining still functional conveying devices in such a manner that the remaining still functional conveying devices remove an air volume flow from the aircraft cabin region which is increased by the same amount.

22. Method according to claim 19,
characterized in that the control device controls, in the event of a failure of a conveying device, at least some of the remaining still functional conveying de-vices in such a manner that the remaining still functional conveying devices remove an air volume flow from the aircraft cabin region which is increased by an amount which is determined by the control device in dependence on at least one parameter.

23. Method according to claim 22,
characterized in that the parameter(s) which is/are used by the control device, in the event of a failure of a conveying device, to control at least some of the remaining still functional conveying devices is/are a parameter characteristic of the arrangement of the remaining still functional conveying devices relative to the failed conveying device and/or a parameter characteristic of the maximum output of the remaining still functional conveying devices.

24. Method according to claim 23,
characterized in that the control device controls, in the event of a failure of a conveying device, the operation of at least some of the remaining still functional conveying devices in dependence on the parameter characteristic of the arrangement of the remaining still functional conveying devices relative to the failed conveying device, in such a manner that the air volume flow removed from the aircraft cabin region by a remaining still functional conveying device is increased by a greater amount, the closer the arrangement of the remaining still functional conveying device to the failed conveying device.
